(19) United States
(12) Patent Application Publication
(10) Pub. No.: US 2006/0233075 A1
(43) Pub. Date: Oct. 19, 2006

(54) METHODS OF CALIBRATING SERVO SIGNAL BIAS FOR OPTICAL DISC

(75) Inventors: Hsin-Chung Yeh, Hsinchu City (TW); Jia-Hau Lin, Wurih Township (TW); Shang-Wei Wu, Yilan City (TW); Jin-Chuan Hsu, Jhudong Township (TW)

Correspondence Address: CONNOLLY BOVE LODGE & HUTZ LLP, SUITE 800, 1990 M STREET NW, WASHINGTON, DC, 20036-3425, US

(73) Assignee: MEDIATEK INC., Hsinchu City (TW)

(21) Appl. No.: 10/907,838

(22) Filed: Apr. 18, 2005

(51) Int. Cl. G11B 7/12

(52) U.S. Cl. 369/47.53

(57) ABSTRACT

Read focus error (FE) bias is calibrated on an embossed area of the optical disc. OPC is then performed with the calibrated servo signal bias to obtain a write power level. Data are written on and read from the optical disc based on the write power level and the calibrated servo signal bias.

### BACKGROUND OF THE INVENTION

1. Field of the Invention

The present invention relates to methods of calibrating servo signal bias for an optical disc, more particularly to methods for calibrating the servo signal bias on an unrecorded or a blank optical disc.

2. Description of the Related Art

There have already been many methods developed for calibrating servo signal bias on an optical disc based on the existing eight to fourteen modulation (EFM) signals recorded on the optical disc. FIG. 1 is a schematic diagram illustrating a method for determining optimal focus error (FE) bias in an optical disc drive. This method is disclosed in Japan Pat. No. 8-077579/1996. The best focus bias voltage V_{B0} is located at the center of focus bias voltages V_{B4} and V_{B3}, which are determined by a reading limit of a groove error (GE) rate curve and a block error (BE) rate curve. Meanwhile, the best jitter point is located at the focus bias voltage V_{B0}, an average of V_{B3} and V_{B4}. However, the BE rate curve is obtained from EFM signals, hence the conventional method is not applicable to an unrecorded or a blank optical disc.

Similarly, Japan Pat. No. 7-201058/1995 and No. 8-249682/1996 further disclose that the adjustment of read FE bias is dependant upon the minimum points PC, PE and PB respectively located on a wobble beat curve GC, a wobble jitter curve GE, and a EFM jitter curve GB and the maximum points PA on an EFM peak-to-peak value curve GA, as shown in FIG. 2. Even though this method is applicable to an unrecorded optical disc, it needs an additional wobble beat detection function to detect the occurrence of the wobble beat. On the other hand, whether the minimum point PC is regarded as the best point of the EFM error rate and EFM jitter is uncertain, which are dependant upon the light path design of the pickup head. Therefore, the ability to apply this method to various optical disc drives is doubtful.

Beside, the optimal read FE bias derived by the previous two proposed methods may not be adequate for a write FE control loop.

Furthermore, Japan Pat. No. 2000306247 puts forth a focus balance adjustment method applicable to a write FE control loop. Under a constant write power, the optical disc drive performs recording tests with various write FE bias levels. The asymmetry of the signals recorded on an optical disc is retrieved by a read back apparatus of the optical disc drive. The write FE bias can thus be calibrated accordingly. FIG. 3 is a graph illustrating the relation between an asymmetry level β and the focus balance disclosed in Japan Pat. No. 2000306247. The read back apparatus is calibrated in advance to compensate the deviation of asymmetry measurements due to variation of different read back apparatuses. Furthermore, it is worthy to notice that the write power and write strategy applied in the recording tests can also influence asymmetry measurement.

FIG. 4 is a flow chart illustrating a conventional method 40 for recording data on a blank optical disc. After inserting a recordable optical disc, the optical disc drive reads the ID (identification data) of the inserted optical disc and recognizes its attribution, as shown in Steps 41 and 42. Referring to Step 43, the inserted optical disc is checked for whether or not it is a blank disc. If the disc has been recorded, the drive can do servo bias level calibration on the EFM data area. If the disc is a blank or unrecorded disc, some bias levels, such as FE bias level, may be determined by a default value. In Step 47, the default FE bias level is used to read back the EFM signal in a power calibration area (PCA), which is recorded for optimum power calibration purpose. Certain errors may be induced since an un-calibrated FE bias is used.

Furthermore, FIG. 5 is a diagram illustrating another conventional method 50 for recording data on a blank optical disc. During the manufacturing process of an optical disc, a suggested asymmetry level is recorded in wobble information of the optical disc, as shown in Step 52. Referring to Step 53, when a user starts to record data on the blank optical disc, the optical disc drive first reads the wobble information for optimum power calibration (OPC). Consequently, a best write power whose asymmetry level is most close to the suggested asymmetry level is chosen. However, as a matter of fact, the read back asymmetry value is different from drive to drive, and the recording quality is also not uniform. The reading variation not only exists in various optical disc drives, but also occurs frequently in different manufacturing lots of the optical discs.

### SUMMARY OF THE INVENTION

An objective of the present invention is to provide an innovative method of calibrating servo signal bias for an optical disc, especially for a blank recordable disc. An optical disc drive performs OPC for a blank disc with a calibrated servo signal bias to obtain an optimal write power level, and it leads to the success of deriving a proper signal at the time of writing.

Another objective of the present invention is to provide a method for calibrating a read servo signal bias on an embossed area of the optical disc. An optimal asymmetry level is obtained by measuring the embossed signal, thus minimizing variation in recording quality from drive to drive.

In order to achieve the objective, methods of calibrating servo signal bias for an optical disc such as the calibration and recording process shown in FIG. 6 are disclosed. The servo signal bias is calibrated on an embossed area of the optical disc (as shown in step 64). OPC is performed with the calibrated servo signal bias to obtain a write power level. Data is then written on and read from the optical disc based on the write power level and the calibrated servo signal bias.

As for the proposed objective, methods of delivering suggested OPC information such as the calibration process shown in FIG. 7 are also disclosed.

The suggested OPC parameters are obtained from the embossed pattern measurement on the optical disc. The embossed pattern measurement is done by the optical drive that is used to record the optical disc. The effect of measurement difference can be eliminated because the optical drive reproduces the parameters according to its own measurements. The parameters are expected to be close to the values read from the PCA during OPC.

In another aspect of the invention, an OPC structure is proposed to search both the optimum write power and the associated write FE bias.

During the proposed OPC process, data is written on a power calibration area (PCA) using a default power with various servo bias levels. Asymmetry information is measured corresponding to the writing. Two servo bias levels are found that match the asymmetry level measured from the embossed area, and a difference between the two servo bias levels is calculated. The write power level is determined according to the calculated servo bias difference. An optimal servo bias level between the two servo bias levels is thus obtained for disc writing.

### BRIEF DESCRIPTION OF THE DRAWINGS

The invention will be described according to the appended drawings in which:

FIG. 1 is a schematic diagram illustrating a method for determining an optimal focus error (FE) bias;

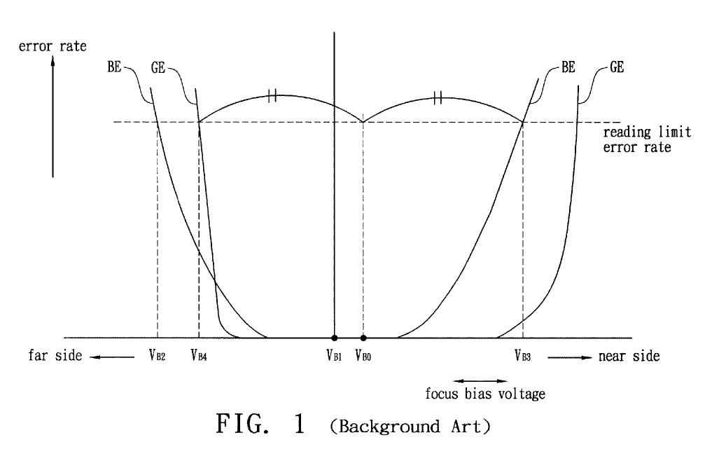

FIG. 2 is a schematic diagram illustrating a method for determining an optimal FE bias;

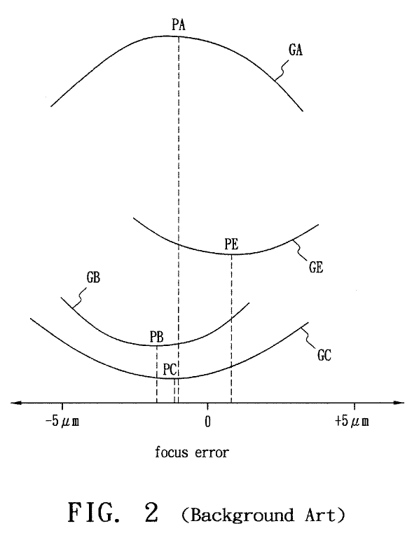

FIG. 3 is a graph illustrating the relation between an asymmetry index β and a focus balance bias;

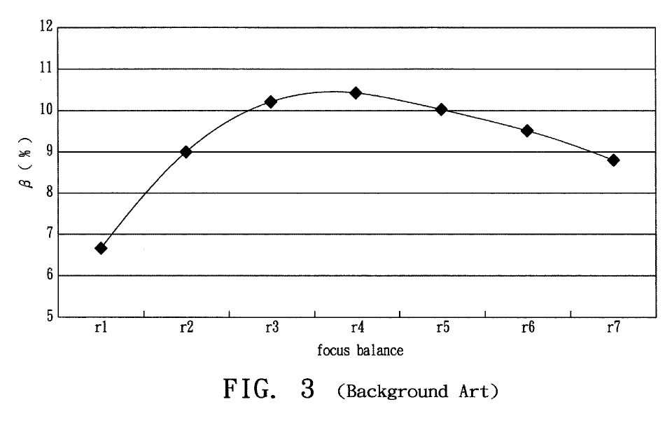

FIG. 4 is a flow chart illustrating a method for recording data on a blank optical disc;

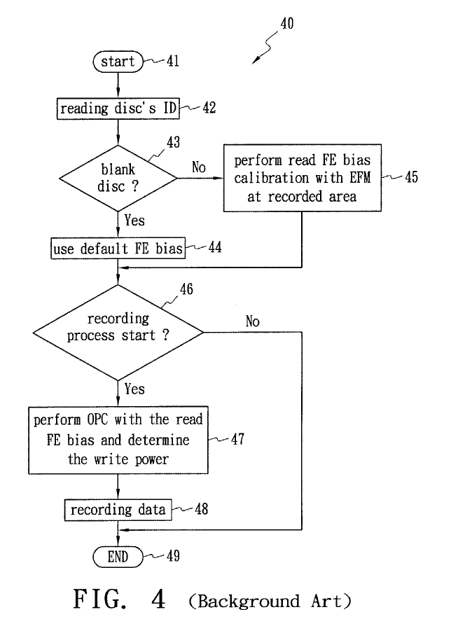

FIG. 5 is a flow chart illustrating a method for delivering suggested OPC parameters;

FIG. 6 is a flow chart illustrating a method for recording data on a blank optical disc in accordance with an embodiment of the invention;

FIG. 7 is a flowchart illustrating a method for delivering OPC recommendation with an optical disc in accordance with an embodiment of the invention; and

FIG. 8 is a schematic diagram for determining an optimal write power and its write FE bias level in accordance with an embodiment of the invention.

### PREFERRED EMBODIMENT OF THE PRESENT INVENTION

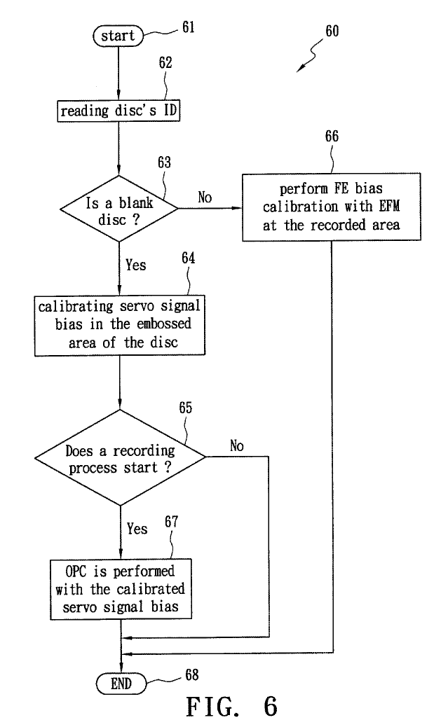

FIG. 6 is a flow chart illustrating a procedure 60 for recording data on a blank optical disc in accordance with an embodiment of the present invention. When an optical disc inserts in an optical disc drive, the optical disc drive reads the ID of the inserted optical disc to recognize its attribution, as show in Steps 61 and 62. In Step 63, the inserted optical disc is checked if it is a blank disc or an unrecorded disc. If the check in Step 63 yields a recorded disc, servo signal bias, such as the read FE bias, can be calibrated in the recorded area of the optical disc, as shown in Step 66. If the inserted optical disc is blank, the optical drive can perform calibration for the servo signal bias in an embossed area of the disc as shown in Step 64.

When the recording process is initiated as shown in Step 65, the OPC process is then performed with the calibrated servo signal bias to obtain a write power level, as shown in Step 67. Before performing the OPC process, reference asymmetry information, such as the asymmetry level β, can be obtained by measuring EFM signals physically embossed on the optical disc. The data can thus be recorded on and read from the optical disc based on the write power level and the calibrated servo signal bias.

The optical disc drive adjusts the laser power for recording data on an optical disc by performing OPC process at the beginning of each write session. The optical drive performs a test burn in a reserved area of the optical disc, such as a power calibration area (PCA), using several levels of laser power, and reads back the area written in the test burn to calculate the optimal laser power for recording. This process is known as OPC process.

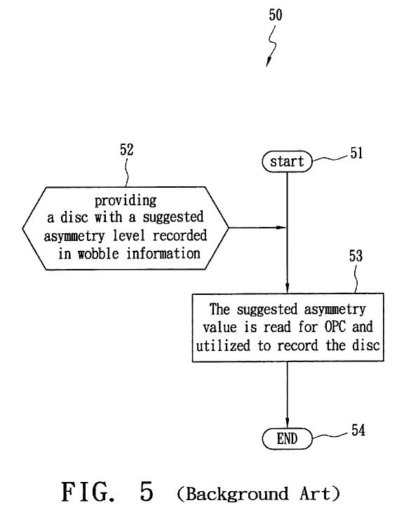

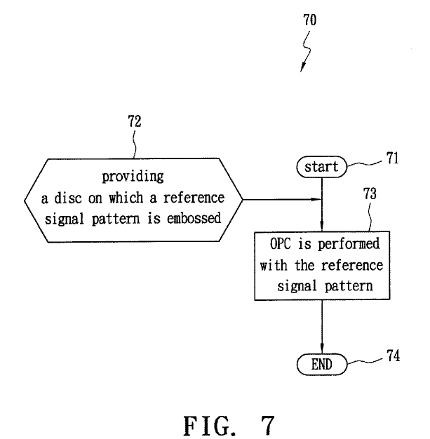

In comparison with FIG. 5, FIG. 7 discloses a method 70 applicable to a blank optical disc with a reference signal pattern so that physical characters of the disc can be obtained from measuring the reference signal pattern of the disc by the optical disc drive. The optical disc drive thus performs the subsequent OPC process based on the reference signal pattern. The blank optical disc is embossed with the reference signal pattern during manufacturing, as shown in Step 72. When a user wishes to record data on the optical disc, the OPC process can be performed with its measuring result of the reference signal pattern, as show in Step 73. The physical characters that can be derived from measuring the reference signal pattern comprise RF asymmetry, RF peak-to-peak value (V_{PP}), duration of a cycle T of a clock signal, maximum amplitude m₃, m₁₁, and m₁₄ of a reflected light signal at 3T, 11T, and 14T recorded marks respectively, reference jitter, and error rate.

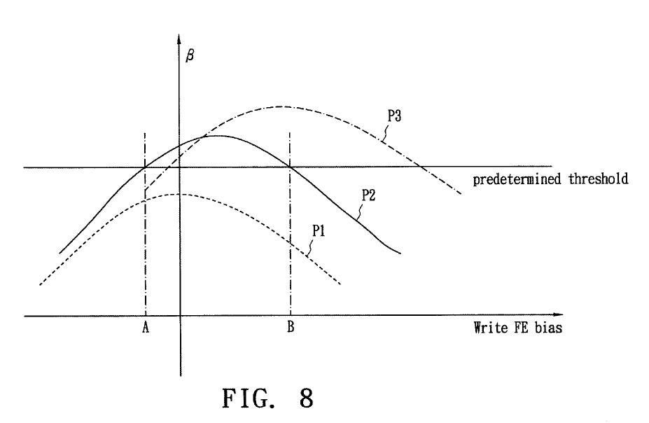

FIG. 8 is a graph illustrating a method for determining an optimal write power level and a write FE bias level in accordance with an embodiment of the present invention. While the OPC process is performed, the optical disc drive writes data on the PCA of the optical disc using various test write power levels and various servo bias levels. FIG. 8 illustrates three EFM characteristic curves, P1, P2, and P3, depicting three different write power levels respectively accompanied with various write FE bias levels. Difference between two write FE bias levels corresponding to a predetermined threshold for the asymmetry measurement (β) is calculated for each curve. The predetermined threshold may be a predetermined optimal asymmetry level previously measured on the embossed area. Some curves may not intersect the predetermined threshold, such as curve P1 shown in FIG. 8, indicating that the write power levels corresponding to these curves are too low and can never meet the predetermined threshold for β. The differences between the two intersections of each curve and the predetermined threshold, for example, δ=|B−A| for curve P2, are calculated for comparison.

If the calculated difference 6 is within a predetermined range defined by an upper threshold δ_{H} and a lower threshold δ_{L}, the write power level corresponding to curve P2 can be used in the succeeding recording process. On the contrary, the write power levels corresponding to curves P1 and P3 are either too large or too small for data recording. When the calculated difference δ of a curve (such as curve P2 of FIG. 8) satisfies the predetermined range δ_{L}<δ<δ_{H}, the optimal write FE bias ε can also be derived from the curve. In an embodiment, the write FE bias is a middle value of the two intersections A and B, that is, ε=(A+B)/2. Eventually, the optimal write power and optimal write FE bias ε are defined and regarded as the best recording parameter settings in the succeeding recording process.

The above-described embodiments of the present invention are intended to be illustrative only. Numerous alternative embodiments may be devised by persons skilled in the art without departing from the scope of the following claims.

What is claimed as new and desired to be protected by Letters Patent of the United States is:

1. A method of calibrating servo signal bias for an optical disc, comprising the steps of:
calibrating the servo signal bias in an embossed area of the optical disc; and
performing optimum power calibration (OPC) with the calibrated servo signal bias to obtain a write power level.

2. The method of calibrating servo signal bias for an optical disc according to claim 1, further comprising recording data to and reading data from the optical disc based on the write power level and the calibrated servo signal bias.

3. The method of calibrating servo signal bias for an optical disc according to claim 1, wherein the embossed area comprises optimum recording information that is physically embossed on the optical disc for an optical disc drive to measure characters thereon for reference of best recording parameter setting.

4. The method of calibrating servo signal bias for an optical disc according to claim 1, wherein the servo signal bias is calibrated according to the measurement of an embossed pattern on the optical disc.

5. The method of calibrating servo signal bias for an optical disc according to claim 4, wherein the measurement of the embossed pattern is an asymmetry level (β).

6. The method of calibrating servo signal bias for an optical disc according to claim 1, wherein the servo signal bias is a read focus error (FE) bias, a write FE bias, or a combination thereof.

7. The method of calibrating servo signal bias for an optical disc according to claim 1, wherein the optical disc is an unrecorded disc.

8. The method of calibrating servo signal bias for an optical disc according to claim 1, further comprising obtaining reference asymmetry information by measuring signal pattern previously embossed for performing OPC.

9. A method of calibrating servo signal bias for an optical disc, comprising the steps of:
calibrating a read servo signal bias on an embossed area of the optical disc;
measuring asymmetry information from the embossed area of the optical disc; and performing optimum power calibration (OPC) process based on the asymmetry information to obtain a write power level.

10. The method of calibrating servo signal bias for an optical disc according to claim 9, further comprising recording data to the optical disc based on the write power level.

11. The method of calibrating servo signal bias for an optical disc according to claim 9, wherein the asymmetry information is physically embossed on the embossed area of the optical disc.

12. The method of calibrating servo signal bias for an optical disc according to claim 9, wherein performing the OPC process further comprising the steps of:
writing data on a power calibration area (PCA) using a default power with various servo bias levels;
measuring asymmetry levels of the previous writing;
calculating a servo bias difference between two servo bias levels matching a predetermined threshold, wherein the predetermined threshold corresponds to the asymmetry level measured on the embossed area;
determining the write power level according to the calculated servo bias difference; and
determining a servo bias level according to the two servo bias levels matching the predetermined threshold for disc writing.

13. The method of calibrating servo signal bias for an optical disc according to claim 12, wherein the selected servo bias level is a middle value of the two servo bias levels.

14. A method of calibrating servo signal bias and write power for an optical disc, comprising the steps of:
writing data on a power calibration area (PCA) of the optical disc using a plurality of test write power levels and servo bias levels;
measuring EFM (eight-to-fourteen modulation) characteristic curve corresponding to various servo bias levels at different test write power levels;
calculating a servo bias difference between two servo bias levels corresponding to a predetermined threshold for each test write power level;
determining the write power level among the test write power levels if the corresponding FE bias difference is within a predetermined range; and
determining an optimum servo bias level according to the two servo bias levels corresponding to the predetermined threshold, thereby writing the optical disc with the optimum servo bias level and corresponding write power level.

15. The method of calibrating servo signal bias and write power for an optical disc according to claim 14, wherein the optimum servo bias level is a middle value of the two servo bias levels corresponding to the predetermined threshold.

16. The method of calibrating servo signal bias and write power for an optical disc according to claim 14, wherein the predetermined threshold is an asymmetry measurement measured from an embossed area of the optical disc.

17. The method of calibrating servo signal bias and write power for an optical disc according to claim 14, wherein the characteristic is an EFM block error rate measurement.

18. A method of manufacturing an optical disc, comprising the step of:
embossing a reference signal pattern on the optical disc whose physical characters can be obtained by an optical disc drive for optimum power calibration (OPC).

19. The method of manufacturing an optical disc according to claim 18, wherein the physical characters are RF asymmetry, RF peak-to-peak amplitude (Vₚₚ), duration of each clock cycle (T), maximum amplitude m₃, m₁₁ and m₁₄ of a reflected light signal at recorded marks with 3T, 11T and 14T length respectively, reference jitter, error rate, or combinations thereof.

20. The method of manufacturing an optical disc according to claim 18, wherein the physical characters are obtained by measuring the embossed area using the optical disc drive.
